(19) United States
(12) Patent Application Publication
(10) Pub. No.: US 2013/0025533 A1
(43) Pub. Date: Jan. 31, 2013

(54) APPARATUS AND METHOD FOR COLORING RECOGNIZABLE TOOL BIT

(71) Applicant: Shao-Hsien Hsu, Taichung City (TW)

(72) Inventor: Shao-Hsien Hsu, Taichung City (TW)

(21) Appl. No.: 13/555,188

(22) Filed: Jul. 22, 2012

Related U.S. Application Data
(63) Continuation-in-part of application No. 13/192,477, filed on Jul. 28, 2011, now abandoned.

(51) Int. Cl. B05C 1/02

(52) U.S. Cl. 118/232

(57) ABSTRACT

An apparatus for coloring a recognizable tool bit includes an operating system and a control system electrically connected to the operating system. The operating system has a rotating mechanism having a rotor extending therefrom for adapting to connect to a tool bit. A supplying mechanism is provided for adapting to store dyestuffs and inject the dyestuffs for coloring the tool bit. A daubing mechanism is relatively connected to the supplying mechanism for soaking dyestuffs from the supplying mechanism and daubing the dyestuff on the tool bit.

### CROSS-REFERENCE TO RELATED APPLICATION

This application is a Continuation-In-Part Application of Ser. No. 13/192,477, filed 28 Jul. 2011, and entitled “APPARATUS AND METHOD FOR COLORING RECOGNIZABLE TOOL BIT”, now pending.

### BACKGROUND OF THE INVENTION

1. Field of the Invention

The present invention relates to a tool bit, and more particularly to an apparatus and a method for coloring a recognizable tool bit.

2. Description of Related Art

A conventional recognizable tool bit includes a tool bit. The tool bit has a head, a neck connected to the head, and an inserter connected to the neck. An aluminum-alloy recognizable ring is sleeved on the neck. The recognizable ring has an outer periphery protruding from the neck. A color of the recognizable ring is provided for recognizing a standard of the tool bit.

The conventional recognizable tool bit provides a recognizable effect for a user to easily recognize the standard of the tool bit during operation. However, it is inconvenient to sleeve the recognizable ring on the neck of the tool bit. Furthermore, the aluminum-alloy recognizable ring increase the production cost.

The present invention has arisen to mitigate and/or obviate the disadvantages of the conventional recognizable tool bit.

### SUMMARY OF THE INVENTION

The main objective of the present invention is to provide an improved method and apparatus for coloring a recognizable tool bit.

To achieve the objective, the method for coloring a recognizable tool bit in accordance with the present invention comprises a rotating mechanism, the rotating mechanism having a rotor extending therefrom for adapting to connect to a tool bit; and a moving mechanism being movable relative to the rotating mechanism and selectively contacted with the rotating mechanism, the moving mechanism including a supplying mechanism provided for adapting to store dyestuffs and inject the dyestuffs for coloring the tool bit, a daubing mechanism relatively connected to the supplying mechanism, the daubing mechanism having a brush mounted thereon, the brush contacted with the supplying mechanism for soaking dyestuffs from the supplying mechanism and daubing the dyestuff on the tool bit, a control system electrically connected to the operating system, the control system having a switch provided for switching on the operating system, the switch being a pedal-typed switch, the control system having a display module mounted and a button assembly, the display module being modified by the button assembly, the button assembly including three buttons. Wherein, the display module has a supplying counter provided for showing an injecting time of the supplying mechanism; one button of the button assembly provided for adjusting a flow rate of the dyestuffs supplied by the supplying mechanism; a rotating counter provided for showing a rotating time of the rotor; wherein the display module has a contacting counter provided for showing a contacting time whereof the brush contacted with the tool bit, another button of the button assembly provided for adjusting a contacting time whereof the brush contacted with the tool bit; wherein the display module has a rotating counter provided for showing a rotating time of the rotor; the other button of the button assembly provided for adjusting a number of cycles of the rotor; wherein the supplying mechanism is a high pressure supplying mechanism.

Under this arrangement, when the switch of the control system is switched on, the rotor of the rotating mechanism rotates the tool bit; the supplying mechanism and the daubing mechanism are moved by the moving mechanism such that the brush contacts with the tool bit for coloring the tool bit to be a recognizable tool bit.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for coloring a recognizable tool bit in accordance with the present invention;

FIG. 2 is a perspective view of an apparatus for coloring a recognizable tool bit in accordance with the present invention;

FIG. 3 is a side plane view of the apparatus for coloring a recognizable tool bit in accordance with the present invention;

FIG. 4 is an operational view of the apparatus for coloring a recognizable tool bit in accordance with the present invention;

FIG. 5 is a partial enlarged pane view of a brush and the rotor in FIG. 4; and

FIG. 6 is a perspective view of a recognizable tool bit colored by the apparatus in accordance with the present invention.

### DETAILED DESCRIPTION OF THE INVENTION

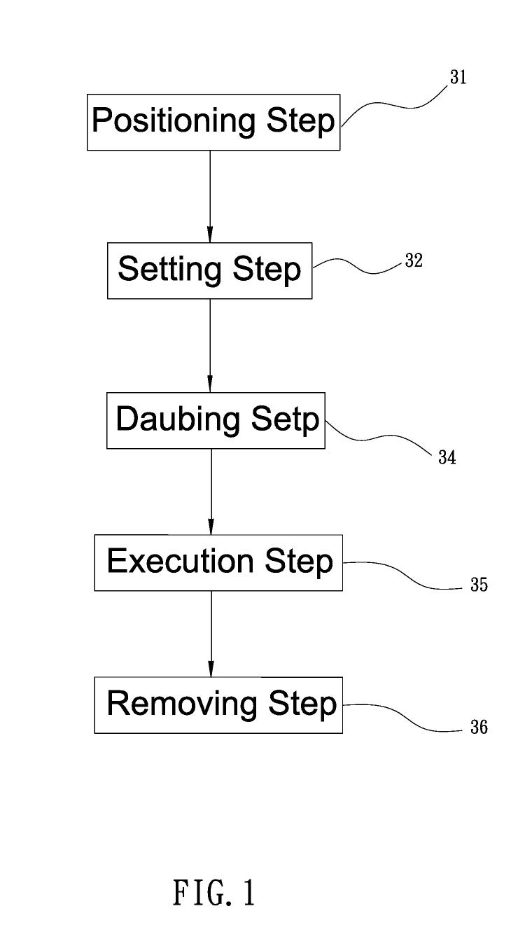

Referring to the drawings and initially to FIG. 1, a method for coloring a recognizable tool bit in accordance with the present invention comprises positioning step 31, setting step 32, daubing step 34, and removing step 35. Positioning step 31: a tool bit is positioned on a rotating mechanism 21. Setting step 32: a pressure of a supplying mechanism 222 is set to adjust a flow rate of the supplying mechanism 222 for deciding a thickness of a color layer of the tool bit. A contacting time is set whereof the daubing mechanism 221 is contacted with the tool bit for adjusting the thickness of the colored layer of the tool bit. A rotating time is set whereof the rotating mechanism 21 rotates the tool bit for adjusting the thickness of the colored layer of the tool bit. Daubing step 34: the daubing means is contacted with the tool bit. The rotating mechanism 21 rotates the tool bit for annularly coloring on an outer periphery of the tool bit. Removing step 35: the colored tool bit is detached from the rotating mechanism 21.

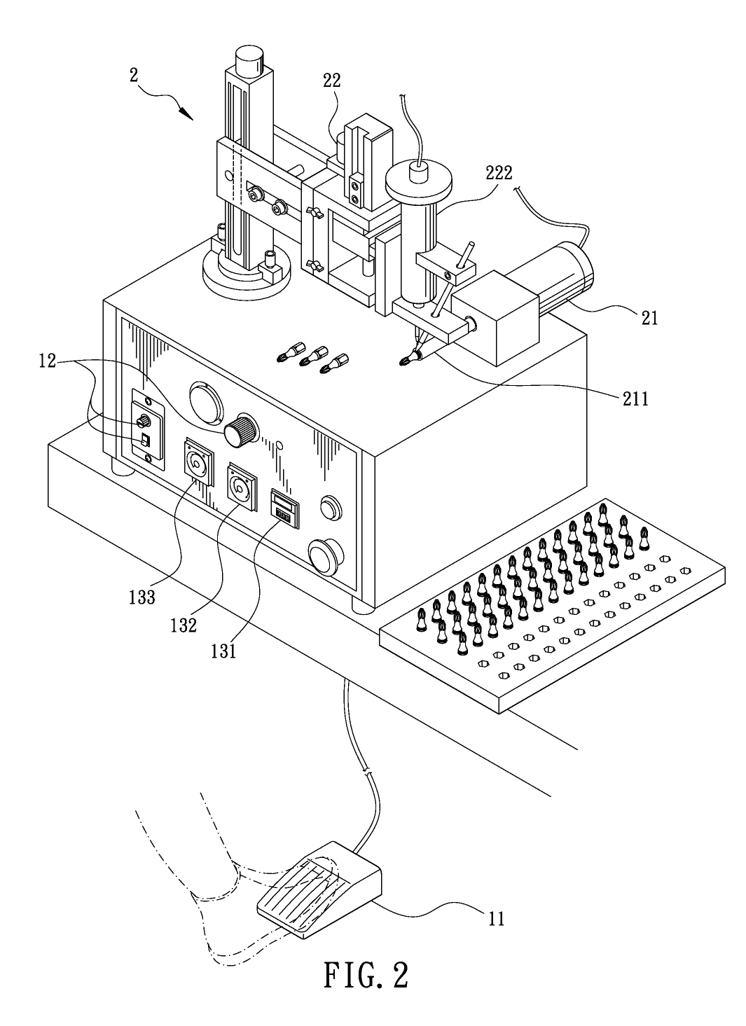

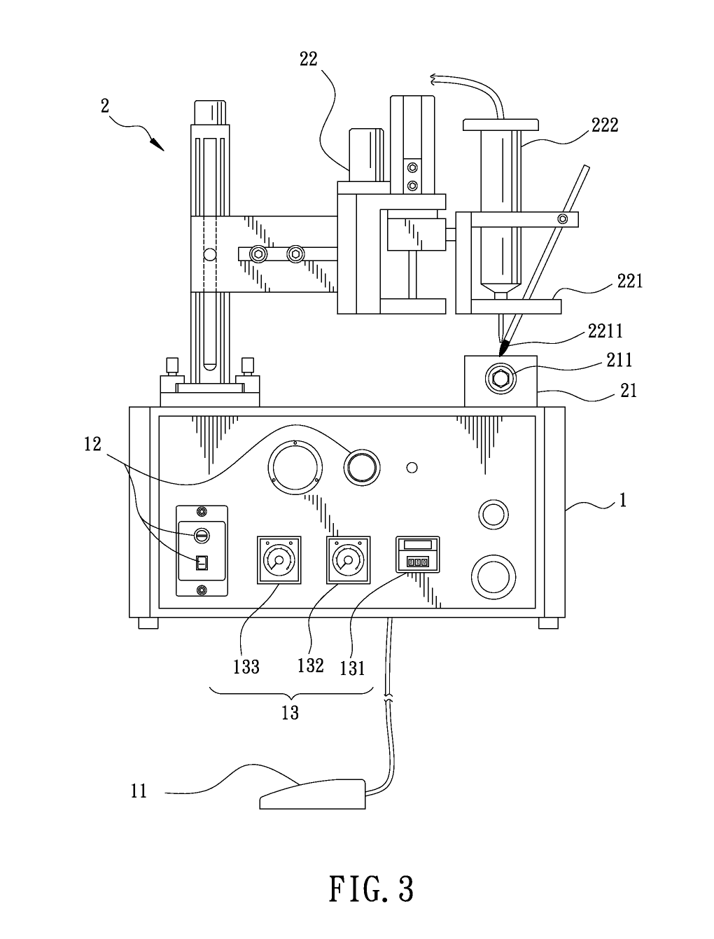

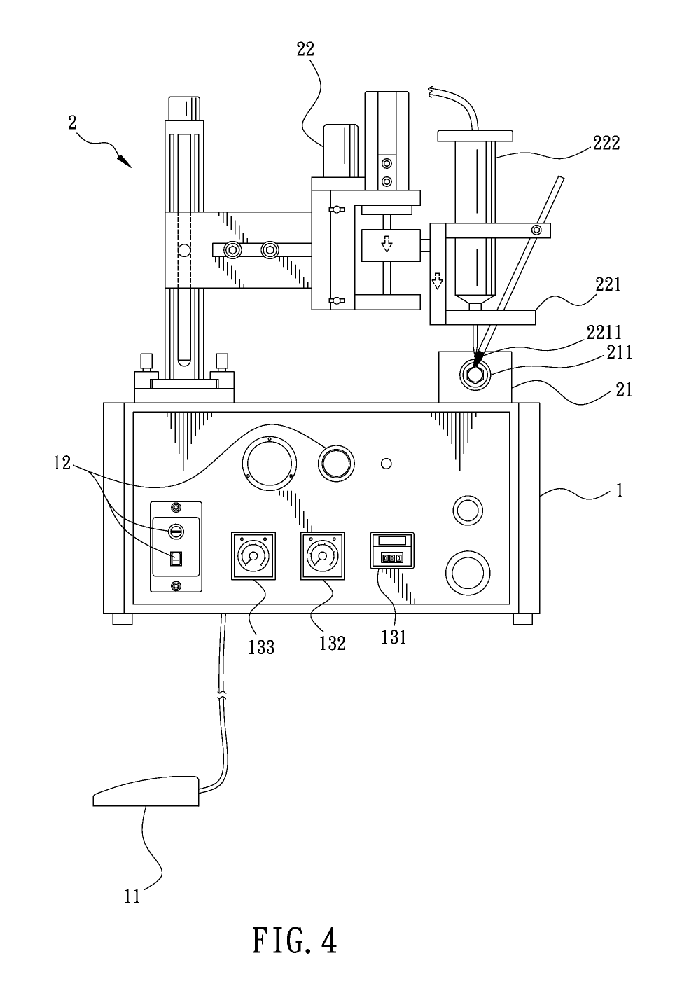

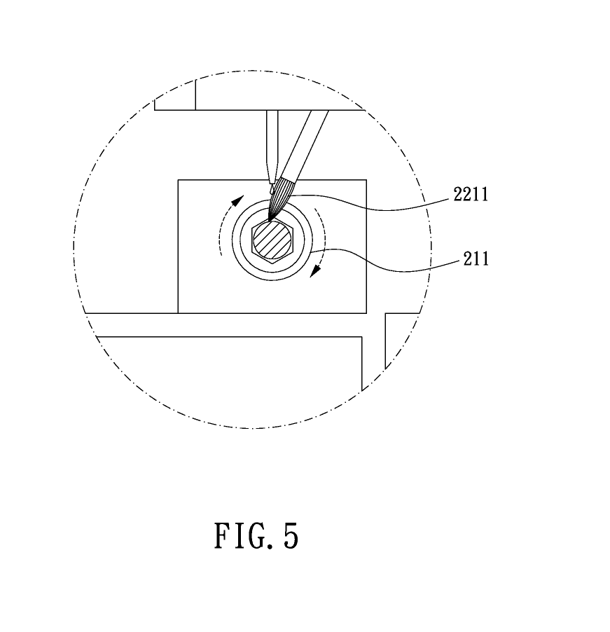

Referring to the drawings and initially to FIGS. 2-6, an apparatus for coloring a recognizable tool bit in accordance with the present invention comprises a control system 1 and an operating system 2 electrically connected to the control system 1.

The operating system 2 includes a rotating mechanism 21 and a moving mechanism 22 mounted adjacent to the rotating mechanism 21. The moving mechanism 22 is movable relative to the rotating mechanism 21 and is selectively contacted with the rotating mechanism 21. The rotating mechanism 21 has a rotor 211 extending therefrom for adapting to connect to a tool bit. The moving mechanism 22 has a supplying mechanism 222 provided for storing dyestuffs (not shown) and injecting the dyestuffs for coloring the tool bit on the rotor 211. The supplying mechanism 222 is a high pressure supplying mechanism. The moving mechanism 22 has a daubing mechanism 221 relatively connected thereto and being adjacent to the supplying mechanism 222. The daubing mechanism 221 has a brush mounted thereon. The brush is selectively contacted with the supplying mechanism 222 for soaking dyestuffs from the supplying mechanism 222 and daubing the dyestuff on the tool bit.

The control system 1 drives the operating system 2. The operating system 2 is mounted on the control system 1. The control system 1 has a pedal-typed switch 11 provided for switching on/off the operating system 2. The control system 1 has a display module 13 mounted thereon. The display module 13 includes a supplying counter 131 provided for showing an injecting time of the supplying mechanism 222, a contacting counter 132 provided for showing a contacting time whereof the brush contacted with the tool bit, and a rotating counter 133 provided for showing a rotating time of the rotor 211. The control system 1 has a button assembly 12 mounted thereon. The display module 13 is modified by the button assembly 12 and the button assembly 12 includes three buttons. One button of the button assembly is provided for adjusting a flow rate of the dyestuffs supplied by the supplying mechanism 222, and another button of the button assembly 12 is provided for adjusting a contacting time whereof the brush contacted with the tool bit, and the other button of the button assembly 12 provides for adjusting a number of cycles of the rotor 211.

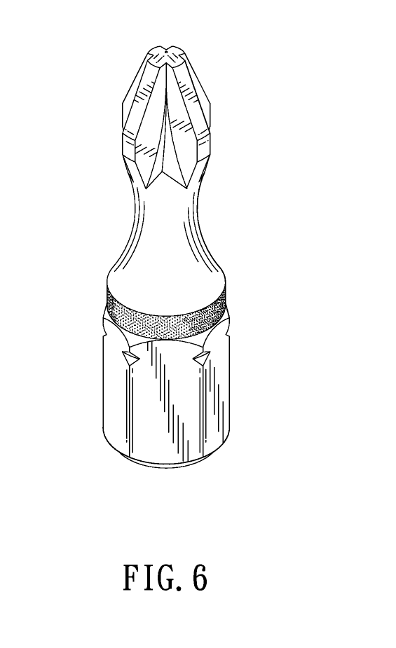

When operating, the tool bit is positioned on the rotor 211. The button assembly 12 is set for adjusting the flow rate of the dyestuffs, the contacting time, the number of cycles of the rotor 211. The display module 13 is provided for correcting the settings of the flow rate, the contacting time, and the number of cycles. The switch 11 of the control system 1 is switched on. The rotor 211 of the rotating mechanism 21 rotates the tool bit. The moving mechanism 22 drives the supplying mechanism 222 and the daubing mechanism 221 to contact with tool. The supplying mechanism 222 injects the dyestuffs on the brush. The brush of the daubing mechanism 221 is contacted with the too bit for coloring the tool bit to be a recognizable tool bit, as shown on FIG. 6.

Although the invention has been explained in relation to its preferred embodiment, it is to be understood that many other possible modifications and variations can be made without departing from the spirit and scope of the invention as hereinafter claimed.

What is claimed is:

1. An apparatus for coloring a recognizable tool bit comprising:
an operating system including:
a rotating mechanism, the rotating mechanism having a rotor extending therefrom for adapting to connect to a tool bit; and
a moving mechanism being movable relative to the rotating mechanism and selectively contacted with the rotating mechanism, the moving mechanism including:
a supplying mechanism provided for adapting to store dyestuffs and inject the dyestuffs for coloring the tool bit; and
a daubing mechanism relatively connected to the supplying mechanism, the daubing mechanism having a brush mounted thereon, the brush contacted with the supplying mechanism for soaking dyestuffs from the supplying mechanism and daubing the dyestuff on the tool bit;
a control system electrically connected to the operating system, the control system having a switch provided for switching on the operating system, the switch being a pedal-typed switch, the control system having a display module mounted and a button assembly, the display module being modified by the button assembly, the button assembly including three buttons;
wherein when the switch of the control system is switched on, the rotor of the rotating mechanism rotates the tool bit, the supplying mechanism and the daubing mechanism are moved by the moving mechanism such that the brush contacts with the tool bit for coloring the tool bit to be a recognizable tool bit.

2. The apparatus for coloring a recognizable tool bit as claimed in claim 1, wherein the display module has a supplying counter provided for showing an injecting time of the supplying mechanism, one button of the button assembly provided for adjusting a flow rate of the dyestuffs supplied by the supplying mechanism, a rotating counter provided for showing a rotating time of the rotor.

3. The apparatus for coloring a recognizable tool bit as claimed in claim 1, wherein the display module has a contacting counter provided for showing a contacting time whereof the brush contacted with the tool bit, another button of the button assembly provided for adjusting a contacting time whereof the brush contacted with the tool bit.

4. The apparatus for coloring a recognizable tool bit as claimed in claim 1, wherein the display module has a rotating counter provided for showing a rotating time of the rotor, the other button of the button assembly provided for adjusting a number of cycles of the rotor.

5. The apparatus for coloring a recognizable tool bit as claimed in claim 1, wherein the supplying mechanism is a high pressure supplying mechanism.
